(19) United States
(12) Patent Application Publication
(10) Pub. No.: US 2024/0271019 A1
(43) Pub. Date: Aug. 15, 2024

(54) UV-CURABLE ADHESIVE COMPOSITION AND ADHESIVE

(71) Applicant: SEKISUI CHEMICAL CO., LTD., Osaka (JP)

(72) Inventors: Shinji KAWADA, Osaka (JP); Tomoki TODA, Osaka (JP); Shuuji KAGE, Tokyo (JP); Chiharu OKUHARA, Osaka (JP); Kaito NEMOTO, Shiga (JP)

(73) Assignee: SEKISUI CHEMICAL CO., LTD., Osaka (JP)

(21) Appl. No.: 18/565,754

(22) PCT Filed: May 30, 2022
(86) PCT No.: PCT/JP2022/021952

§ 371 Date: Nov. 30, 2023

(30) Foreign Application Priority Data
Jun. 2, 2021 (JP) 2021-093189

(51) Int. Cl. C09J 133/10; C08F 2/44; C08F 2/50; C08F 220/18; C09J 4/00; C09J 11/06; C09J 11/08

(52) U.S. Cl. CPC C09J 133/10; C08F 2/44; C08F 2/50; C08F 220/1811; C09J 4/00; C09J 11/06; C09J 11/08

(57) ABSTRACT

The present invention aims to provide a UV-curable adhesive composition having excellent printability, excellent UV reactivity in the presence of oxygen, and excellent adhesion to various substrates. The present invention also aims to provide an adhesive containing the UV-curable adhesive composition. Provided is a UV-curable adhesive composition containing: (A) a nitrogen-containing monomer; (B) a monofunctional (meth)acrylate monomer; (C) a crosslinking component; (D) a photopolymerization initiator; and (E) a thermoplastic resin having no reactivity with the nitrogen-containing monomer (A) nor with the monofunctional (meth)acrylate monomer (B), a cured product being obtained by applying the composition to a substrate at a thickness of 150 μm and irradiating the composition with UV light having a wavelength of 315 nm to 480 nm at an irradiance of 90 mW/cm² and a dose of 1,350 mJ/cm² in an atmospheric environment, the cured product having a reaction percentage of 80% or higher on both a surface facing the atmosphere and a surface facing the substrate.

### TECHNICAL FIELD

The present invention relates to a UV-curable adhesive composition having excellent printability, excellent UV reactivity in the presence of oxygen, and excellent adhesion to various substrates. The present invention also relates to an adhesive containing the UV-curable adhesive composition.

### BACKGROUND ART

Adhesives are used to bond electronic components inside electronic devices such as smartphones and PCs. With a typical method of bonding using an adhesive, first, an adhesive sheet having separators on both surfaces of an adhesive is produced. Next, the adhesive sheet is cut to a desired shape. One separator is then removed from the cut adhesive sheet, and the exposed adhesive surface is bonded to a first adherend. Subsequently, the other separator is removed, and the exposed adhesive surface is bonded to a second adherend. With this method, part of the adhesive sheet is discarded after cutting, producing waste. In addition, air bubbles may be trapped at the bonding interface.

In view of the situation, methods have been studied in which no adhesive sheet is produced and an adhesive composition is printed in a predetermined shape before being bonded to an adherend. These methods can reduce waste production and also prevent air bubbles at the bonding interface.

For example, Patent Literature 1 discloses an invention to provide a radiation curable adhesive composition that allows fine patterning and exhibits high adhesion to various adherends such as metals and plastics. The radiation curable adhesive resin composition contains 10 to 70% by weight of an ethylenically unsaturated monomer not containing an aromatic ring, 1 to 10% by weight of a photopolymerization initiator, and 10 to 55% by weight of a crosslinking agent, wherein the composition contains 10 to 45% by weight of an alkyl (meth)acrylate having a C8-C18 alkyl group as the ethylenically unsaturated monomer not containing an aromatic ring and 10 to 50% by weight of a urethane poly(meth)acrylate having a weight average molecular weight of 20,000 to 100,000 as the crosslinking agent.

Patent Literature 2 discloses an invention to provide a photocurable adhesive composition that, even when irradiated with light in the presence of oxygen, gives a laminate having adhesive strength equivalent to that in the absence of oxygen. The photocurable adhesive composition contains (A) a (meth)acrylate oligomer, (B) a monofunctional (meth)acrylate monomer, (C) a bi- to tetra-functional (meth)acrylate monomer, (D) a photoreaction initiator, (E) a tackifier having a softening point of 70° C. to 150° C., and (F) a liquid plasticizer.

### CITATION LIST

### Patent Literature

Patent Literature 1: JP 2013-216742 A
Patent Literature 2: WO 2016/163152

### SUMMARY OF INVENTION

### Technical Problem

As described above, the methods in which no adhesive sheet is produced and an adhesive composition is printed in a predetermined shape before being bonded to an adherend can reduce waste production and also prevent air bubbles at the bonding interface. The adhesive composition is preferably cured with UV light to avoid heating adherends. However, curing the adhesive composition exposed and not covered with a separator may result in insufficient UV reactivity and insufficient adhesion to substrates. There is thus still room for improvement to provide a UV light-curable composition for printing that has excellent printability, excellent UV reactivity, and excellent adhesion to various substrates.

The present invention aims to provide a UV-curable adhesive composition having excellent printability, excellent UV reactivity in the presence of oxygen, and excellent adhesion to various substrates. The present invention also aims to provide an adhesive containing the UV-curable adhesive composition.

### Solution to Problem

The present disclosure 1 relates to a UV-curable adhesive composition containing: (A) a nitrogen-containing monomer; (B) a monofunctional (meth)acrylate monomer; (C) a crosslinking component; (D) a photopolymerization initiator; and (E) a thermoplastic resin having no reactivity with the nitrogen-containing monomer (A) nor with the monofunctional (meth)acrylate monomer (B), a cured product being obtained by applying the composition to a substrate at a thickness of 150 μm and irradiating the composition with UV light having a wavelength of 315 nm to 480 nm at an irradiance of 90 mW/cm² and a dose of 1,350 mJ/cm² in an atmospheric environment, the cured product having a reaction percentage of 80% or higher on both a surface facing the atmosphere and a surface facing the substrate.

The present disclosure 2 relates to the UV-curable adhesive composition of the present disclosure 1, wherein the nitrogen-containing monomer (A) is contained in an amount of 10 to 35% by weight.

The present disclosure 3 relates to the UV-curable adhesive composition of the present disclosure 1 or 2, further containing a defoamer.

The present disclosure 4 relates to the UV-curable adhesive composition of the present disclosure 1, 2, or 3, wherein the cured product has a glass transition temperature of 20° C. to −30° C.

The present disclosure 5 relates to the UV-curable adhesive composition of the present disclosure 1, 2, 3 or 4, which is used for screen printing.

The present disclosure 6 relates to an adhesive obtained by printing the UV-curable adhesive composition of the present disclosure 1, 2, 3, 4, or 5 and irradiating the curable adhesive composition with UV light.

The present disclosure 7 relates to an adhesive sheet including: a substrate; and an adhesive layer on at least one surface of the substrate, the adhesive layer containing the UV-curable adhesive composition of the present disclosure 1, 2, 3, 4 or 5.

The present disclosure 8 relates to an adhesive sheet of the present disclosure 7, wherein the adhesive layer is disposed on part of the substrate.

The present disclosure 9 relates to a laminate including a first adherend and a second adherend bonded to each other with the adhesive layer of the adhesive sheet of the present disclosure 7 or 8.

The present disclosure 10 relates to a method for producing a laminate, including: applying the UV-curable adhesive composition of the present disclosure 1, 2, 3, 4 or 5 to a first adherend; exposing the UV-curable adhesive composition to light to form an adhesive layer; and bonding a second adherend to the adhesive layer to form a laminate.

The present disclosure 11 relates to the method for producing a laminate of the present disclosure 10, wherein the UV-curable adhesive composition is applied by ink-jet printing, screen printing, spray coating, spin coating, gravure offset printing, or reverse offset printing, and the UV-curable adhesive composition is applied to part of the first adherend.

The present invention is described in detail below.

The present inventors have found out that it is difficult for conventional adhesive compositions to have sufficient UV reactivity when they are exposed and not covered with a separator during curing. After further studies, the inventors have found out that using (A) a nitrogen-containing monomer can improve the UV reactivity in the presence of oxygen. Furthermore, the inventors also have found out that combined use of the nitrogen-containing monomer (A) with (B) a monofunctional (meth)acrylate monomer, (C) a crosslinking component, and (E) a thermoplastic resin having no reactivity with the nitrogen-containing monomer (A) nor with the monofunctional (meth)acrylate monomer (B) can ensure the printability and the adhesion to various substrates. Moreover, the inventors have found out that adjusting the reaction percentage of the cured product of the composition to 80% or higher on both a surface facing the atmosphere and a surface facing a substrate result in excellent UV reactivity in the presence of oxygen and excellent adhesion to various substrates. The inventors thus completed the present invention.

The UV-curable adhesive composition contains (A) a nitrogen-containing monomer. The nitrogen-containing monomer may be any monomer having a nitrogen atom and a polymerizable group in the molecule. The nitrogen-containing monomer is preferably an amide compound having a vinyl group, more preferably a cyclic amide compound having a vinyl group, still more preferably a compound having a lactam structure.

Examples of the amide compound having a vinyl group include N-vinylacetamide and (meth)acrylamide compounds. Examples of the (meth)acrylamide compounds include N,N-dimethyl(meth)acrylamide, N-(meth)acryloylmorpholine, N-hydroxyethyl(meth)acrylamide, N,N-diethyl(meth)acrylamide, N-isopropyl(meth)acrylamide, and N,N-dimethylaminopropyl(meth)acrylamide.

Examples of the cyclic amide compound having a vinyl group include compounds represented by the following formula (1).

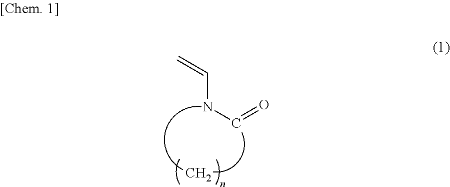

In the formula (1), n represents an integer of 2 to 6.

Examples of the compounds represented by the formula (1) include N-vinyl-2-pyrrolidone and N-vinyl-ε-caprolactam. In particular, N-vinyl-ε-caprolactam is preferred.

The nitrogen-containing monomer preferably includes a monomer having a negative e value. Examples of the monomer having a negative e value include N-vinylacetamide (e value=−1.57), N-vinyl-ε-caprolactam (e value=−1.18), N-vinyl-2-pyrrolidone (e value=−1.62), and N,N-dimethyl(meth)acrylamide (e value=−0.26).

The amount of the nitrogen-containing monomer is adjusted such that a cured product of the composition can have a reaction percentage of 80% or higher on both a surface facing the atmosphere and a surface facing a substrate. Specifically, the amount of the nitrogen-containing monomer is preferably 10 to 35% by weight relative to 100% by weight of the UV-curable adhesive composition. When the amount of the nitrogen-containing monomer is 10% by weight or more, the UV reactivity in the presence of oxygen can be improved, making it easy for the cured product to have a reaction percentage of 80% or higher on both the surface facing the atmosphere and the surface facing the substrate. When the amount of the nitrogen-containing monomer is 35% by weight or less, the resulting adhesive has excellent adhesion to various substrates. The upper limit of amount of the nitrogen-containing monomer is more preferably 25% by weight.

The UV-curable adhesive composition contains (B) a monofunctional (meth)acrylate monomer.

The “(meth)acryl” herein means acryl or methacryl. The “(meth)acrylate monomer” means a monomer having a (meth)acryloyl group. The “(meth)acryloyl” means acryloyl or methacryloyl. The “monofunctional” herein means containing one (meth)acryloyl group in one monomer molecule. Here, a monomer having a (meth)acryloyl group and nitrogen is not treated as the monofunctional (meth)acrylate monomer (B) but treated as the nitrogen-containing monomer (A).

Examples of the (meth)acrylate monomer include (meth)acrylate compounds and epoxy (meth)acrylates.

The “(meth)acrylate” herein means acrylate or methacrylate. The “epoxy (meth)acrylate” means a compound obtained by reacting all the epoxy groups in an epoxy compound with (meth)acrylic acid.

Examples of monofunctional (meth)acrylate compounds include methyl (meth)acrylate, ethyl (meth)acrylate, propyl (meth)acrylate, n-butyl (meth)acrylate, isobutyl (meth)acrylate, t-butyl (meth)acrylate, 2-ethylhexyl (meth)acrylate, n-octyl (meth)acrylate, n-heptyl (meth)acrylate, isooctyl (meth)acrylate, isononyl (meth)acrylate, isodecyl (meth)acrylate, lauryl (meth)acrylate, isomyristyl (meth)acrylate, stearyl (meth)acrylate, 2-hydroxyethyl (meth)acrylate, 2-hydroxypropyl (meth)acrylate, 2-hydroxy-3-phenoxypropyl (meth)acrylate, 2-hydroxybutyl (meth)acrylate, 4-hydroxybutyl (meth)acrylate, cyclohexyl (meth)acrylate, isobornyl (meth)acrylate, bicyclopentenyl (meth)acrylate, benzyl (meth)acrylate, 2-methoxyethyl (meth)acrylate, 2-ethoxyethyl (meth)acrylate, 2-butoxyethyl (meth)acrylate, 2-phenoxyethyl (meth)acrylate, methoxyethylene glycol (meth)acrylate, methoxypolyethylene glycol (meth)acrylate, phenoxydiethylene glycol (meth)acrylate, phenoxypolyethylene glycol (meth)acrylate, tetrahydrofurfuryl (meth)acrylate, tetrahydrofurfuryl alcohol acrylic acid multimer ester, ethyl carbitol (meth)acrylate, 2,2,2,-trifluoroethyl (meth)acrylate, 2,2,3,3-tetrafluoropropyl (meth)acrylate, 1H, 1H, 5H-octafluoropentyl (meth)acrylate, imide (meth)acrylate, dimethylaminoethyl (meth)acrylate, diethylaminoethyl (meth)acrylate, 2-(meth)acryloyloxyethyl succinate, 2-(meth)acryloyloxyethyl hexahydrophthalate, 2-(meth)acryloyloxyethyl 2-hydroxypropylphthalate, 2-(meth)acryloyloxyethyl phosphate, (3-ethyloxetan-3-yl) methyl (meth)acrylate, 2-(((butylamino) carbonyl)oxy) ethyl (meth)acrylate, (3-propyloxetan-3-yl) methyl (meth)acrylate, (3-butyloxetan-3-yl) methyl (meth)acrylate, (3-ethyloxetan-3-yl) ethyl (meth)acrylate, (3-ethyloxetan-3-yl) propyl (meth)acrylate, (3-ethyloxetan-3-yl) butyl (meth)acrylate, (3-ethyloxetan-3-yl) pentyl (meth)acrylate, (3-ethyloxetan-3-yl) hexyl (meth)acrylate, γ-butyrolactone (meth)acrylate, (2,2-dimethyl-1,3-dioxolan-4-yl) methyl (meth)acrylate, (2-methyl-2-ethyl-1,3-dioxolan-4-yl) methyl (meth)acrylate, (2-methyl-2-isobutyl-1,3-dioxolan-4-yl) methyl (meth)acrylate, (2-cyclohexyl-1,3-dioxolan-4-yl) methyl (meth)acrylate, and cyclic trimethylolpropane formal acrylate.

Examples of the epoxy (meth)acrylates include bisphenol A epoxy (meth)acrylate, bisphenol F epoxy (meth)acrylate, bisphenol E epoxy (meth)acrylate, and caprolactone-modified products of these.

The lower limit of the amount of the monofunctional (meth)acrylate monomer in 100 parts by weight of the UV-curable adhesive composition is preferably 20 parts by weight, and the upper limit thereof is preferably 70 parts by weight. When the amount of the monofunctional (meth)acrylate monomer is 20 parts by weight or more, the resulting adhesive can have excellent adhesion to various substrates. When the amount of the monofunctional (meth)acrylate monomer is 70 parts by weight or less, the adhesive can be excellent in other properties than adhesion. The lower limit of the amount of the monofunctional (meth)acrylate monomer is more preferably 28 parts by weight, and the upper limit thereof is more preferably 60 parts by weight.

The UV-curable adhesive composition contains (C) a crosslinking component. The crosslinking component may be any compound having two or more binding functional groups in one molecule. The crosslinking component is preferably one having reactivity with the nitrogen-containing monomer (A) and the monofunctional (meth)acrylate monomer (B) or one having reactivity with the nitrogen-containing monomer (A), the monofunctional (meth)acrylate monomer (B), and a thermoplastic resin (E).

The crosslinking component (C) preferably has at least one binding functional group selected from the group consisting of an isocyanate group, an epoxy group, an aldehyde group, a hydroxy group, an amino group, a (meth)acrylate group, and a vinyl group. A crosslinking component having any of these binding functional groups can form crosslinking bonds at a sufficient density in curing.

The crosslinking component (C) preferably contains a (meth)acrylate monomer that in the form of a homopolymer has a gel fraction of 80% or higher. Using such a (meth)acrylate monomer can improve the cohesive force of the UV-curable adhesive composition, improving the printability of the composition and the adhesion of the resulting adhesive.

The crosslinking component (C) preferably contains a (meth)acrylate monomer having a viscosity at 25° C. of 10,000 cps or higher. The crosslinking component (C) preferably contains a bifunctional (meth)acrylate monomer. Using such a (meth)acrylate monomer can improve the cohesive force of the UV-curable adhesive composition, improving the printability of the composition and the adhesion of the resulting adhesive.

Specific examples of the crosslinking component (C) include: radically polymerizable polyfunctional oligomers and monomers; and polymers having a crosslinkable functional group.

Examples of the radically polymerizable polyfunctional oligomers and monomers include trimethylolpropane triacrylate, tetramethylolmethane tetraacrylate, pentaerythritol triacrylate, pentaerythritol tetraacrylate, dipentaerythritol monohydroxypentaacrylate, dipentaerythritol hexaacrylate, and methacrylates of the same kinds. Other examples include 1,4-butylene glycol diacrylate, 1,6-hexanediol diacrylate, polyethylene glycol diacrylate, commercial oligoester acrylates, and methacrylates of the same kinds. These radically polymerizable polyfunctional oligomers and monomers may be used alone or in combination of two or more thereof.

The amount of the crosslinking component (C) is preferably 0.1 to 25% by weight in 100% by weight of the total amount of the nitrogen-containing monomer (A), the monofunctional (meth)acrylate monomer (B), and the crosslinking component (C). When the amount of the crosslinking component (C) is within the range, the cohesive force of the UV-curable adhesive composition can be appropriately improved, and the printability of the composition and the adhesion of the resulting adhesive can be improved. The lower limit of the amount of the crosslinking component (C) is more preferably 2% by weight, and the upper limit thereof is more preferably 15% by weight.

The UV-curable adhesive composition contains (D) a photopolymerization initiator.

The photopolymerization initiator is preferably a photoradical polymerization initiator. The photopolymerization initiator and the photoradical polymerization initiator may be used alone or in combination of two or more thereof.

Examples of the photoradical polymerization initiator include benzophenone compounds, alkylphenone compounds, acylphosphine oxide compounds, titanocene compounds, oxime ester compounds, benzoin ether compounds, and thioxanthone compounds. Examples of the alkylphenone compounds include acetophenone compounds. When two or more photoradical polymerization initiators are used in combination, an alkylphenone compound and an acylphosphine oxide compound are preferably used in combination to improve the adhesion of the resulting adhesive.

Specific examples of the photoradical polymerization initiator include 1-hydroxycyclohexyl phenyl ketone, 2-benzyl-2-(dimethylamino)-1-(4-((morpholino)phenyl)-1-butanone, 2-(dimethylamino)-2-((4-methylphenyl)methyl)-1-(4-(4-morpholinyl)phenyl)-1-butanone, 2,2-dimethoxy-1,2-diphenylethan-1-one, bis(2,4,6-trimethylbenzoyl)phenylphosphine oxide, 2-methyl-1-(4-methylthiophenyl)-2-morpholinopropan-1-one, 1-(4-(2-hydroxyethoxy)-phenyl)-2-hydroxy-2-methyl-1-propan-1-one, 1-(4-(phenylthio)phenyl)-1,2-octanedione-2-(O-benzoyl oxime), 2,4,6-trimethylbenzoyl diphenylphosphine oxide, benzoin methyl ether, benzoin ethyl ether, and benzoin isopropyl ether. When two or more photoradical polymerization initiators are used in combination, 1-hydroxycyclohexyl phenyl ketone as an alkylphenone compound and bis(2,4,6-trimethylbenzoyl)phenylphosphine oxide and/or 2,4,6-trimethylbenzoyldiphenylphosphine oxide as acylphosphine oxide compound (s) are preferably used to improve the adhesion of the resulting adhesive.

The lower limit of the amount of the photopolymerization initiator is preferably 0.2 parts by weight, and the upper limit thereof is preferably 10 parts by weight, relative to 100 parts by weight of the total amount of the nitrogen-containing monomer (A) and the monofunctional (meth)acrylate monomer (B). When the amount of the photopolymerization initiator is within the range, the UV-curable adhesive composition can have excellent UV curability while maintaining excellent storage stability. Moreover, when the amount of photopolymerization initiator is 0.2 parts by weight or more, the adhesion of the resulting adhesive is further improved. The lower limit of the amount of the photopolymerization initiator is more preferably 0.5 parts by weight, still more preferably 1.0 parts by weight, particularly preferably 1.5 parts by weight, and the upper limit thereof is more preferably 5 parts by weight, still more preferably 3 parts by weight, particularly preferably 2.5 parts by weight, most preferably 2 parts by weight. When two or more photopolymerization initiators are contained, the amount of the photopolymerization initiator refers to the total amount of all the photopolymerization initiators contained.

The UV-curable adhesive composition contains (E) a thermoplastic resin having no reactivity with the nitrogen-containing monomer (A) nor with the monofunctional (meth)acrylate monomer (B). The thermoplastic resin may be a compound containing no reactive double bond therein or a compound containing a reactive double bond but showing substantially no photopolymerizability. The thermoplastic resin may show reactivity with a trigger such as heat or moisture after the UV-curable adhesive composition is photopolymerized. For example, the thermoplastic resin may contain an epoxy resin to be cured by heat or may contain an isocyanate compound to be cured by moisture or alcohol.

Specific examples of the thermoplastic resin include solvent-free acrylic polymers.

Examples of the solvent-free acrylic polymers include: polymers of at least one monomer selected from alkyl (meth)acrylates having a C1-C20 alkyl group; and copolymers of this monomer and other copolymerizable monomer (s).

Examples of commercial solvent-free acrylic polymers include ARUFON UP-1000 series, UH-2000 series, and UC-3000 series available from Toagosei Co., Ltd. and acrylic block copolymers KURARITY LA series and LK series available from Kuraray Co., Ltd.

The amount of the thermoplastic resin is preferably in a ratio of 0.1 to 140 parts by weight to 100 parts by weight of the total amount of the nitrogen-containing monomer (A) and the monofunctional (meth)acrylate monomer (B). When the amount of the thermoplastic resin is within the range, the UV-curable adhesive composition can have improved viscosity, so that the composition can form a thick coating film, have excellent printability, and also reduce a decrease in adhesiveness at high temperature. The lower limit of the amount of the thermoplastic resin is more preferably 10 parts by weight, and the upper limit thereof is more preferably 90 parts by weight.

The UV-curable adhesive composition may contain a plasticizer such as an organic acid ester, an organophosphate ester, or an organophosphite ester.

Examples of the plasticizer include organic acid ester plasticizers such as monobasic organic acid esters and polybasic organic acid esters and phosphoric acid plasticizers such as organophosphate plasticizers and organophosphite plasticizers. Preferred among these are organic acid ester plasticizers. These plasticizers may be used alone or in combination of two or more thereof.

Examples of the organic acid esters include monobasic organic acid esters and polybasic organic acid esters.

Non-limiting examples of the monobasic organic acid esters include glycol esters obtained by reaction between a monobasic organic acid (e.g., butyric acid, isobutyric acid, caproic acid, 2-ethyl butyric acid, heptylic acid, n-octylic acid, 2-ethylhexanoic acid, pelargonic acid (n-nonylic acid), or decylic acid) and a glycol (e.g., triethylene glycol, tetraethylene glycol, or tripropylene glycol).

Non-limiting examples of the polybasic organic acid esters include ester compounds obtained by reaction between a polybasic organic acid (e.g., adipic acid, sebacic acid, or azelaic acid) and a C4-C8 linear or branched alcohol.

Specific examples of the organic acid esters include triethylene glycol-di-2-ethylbutyrate (3GH), triethylene glycol-di-2-ethylhexanoate (3GO), triethylene glycol dicaprylate, triethylene glycol di-n-octanoate, and triethylene glycol-di-n-heptanoate (3G7). Examples also include tetraethylene glycol-di-n-heptanoate (4G7), tetraethylene glycol-di-2-ethylhexanoate, dibutyl sebacate, dioctyl azelate, dibutyl carbitol adipate, ethylene glycol di-2-ethylbutyrate, and 1,3-propylene glycol di-2-ethylbutyrate. Examples further include 1,4-butylene glycol di-2-ethylbutyrate, diethylene glycol-di-2-ethylbutyrate, diethylene glycol-di-2-ethylhexanoate, and dipropylene glycol di-2-ethylbutyrate. Examples further include triethylene glycol di-2-ethylpentanoate, tetraethylene glycol-di-2-ethylbutyrate (4GH), diethylene glycol dicaprylate, dihexyl adipate (DHA), dioctyl adipate, hexyl cyclohexyl adipate, diisononyl adipate, and heptyl nonyl adipate. Examples also include oil-modified sebacic alkyds, mixtures of phosphates and adipates, and mixed type adipates prepared from C4-C9 alkyl alcohols and C4-C9 cyclic alcohols.

The organophosphate ester or organophosphite ester may be a compound obtained by condensation reaction between phosphoric acid or phosphorous acid and an alcohol. In particular, preferred is a compound obtained by condensation reaction between a C1-C12 alcohol and phosphoric acid or phosphorous acid. Examples of the C1-C12 alcohol include methanol, ethanol, butanol, hexanol, 2-ethyl butanol, heptanol, octanol, 2-ethylhexanol, decanol, dodecanol, butoxy ethanol, butoxyethoxy ethanol, benzyl alcohol.

Specific examples of the organophosphate ester or organophosphite ester include trimethyl phosphate, triethyl phosphate, tripropyl phosphate, tributyl phosphate, tri(2-ethylhexyl) phosphate, tri(butoxyethyl) phosphate, tri(2-ethylhexyl) phosphite, isodecylphenyl phosphate, and triisopropyl phosphate.

The UV-curable adhesive composition may contain a tackifier such as a rosin resin or terpene resin.

The rosin resin may be, for example, a rosin diol.

The rosin diol may be any rosin-modified diol having two rosin skeletons and two hydroxy groups in the molecule. Diols having a rosin component in the molecule are generically referred to as rosin polyols. Rosin polyols are classified into the polyether type in which the skeleton excluding that of the rosin component is like polypropylene glycol (PPG) and the polyester type such as condensed polyester polyols, lactone-type polyester polyols, and polycarbonate diols.

Examples of the rosin diol include rosin esters obtained by reaction between a rosin and a polyhydric alcohol, epoxy-modified rosin esters obtained by reaction between a rosin and an epoxy compound, and modified rosins having a hydroxy group such as polyethers having a rosin skeleton. These can be produced by a conventionally known method.

Examples of the rosin component include abietic acid and its derivatives (e.g., dehydroabietic acid, dihydroabietic acid, tetrahydroabietic acid, diabietic acid, neoabietic acid), pimaric acid-type resin acids such as levopimaric acid, hydrogenated rosins obtained by hydrogenation of these, and disproportionated rosins obtained by disproportionation of these.

Examples of commercial products of the rosin resin include Pine crystal series (D-6011, KE-615-3, KR-614, KE-100, KE-311, KE-359, KE-604, D-6250) available from Arakawa Chemical Industries, Ltd.

Examples of the terpene resin include terpene phenolic resins.

The terpene phenolic resin is a copolymer of a phenol and a terpene resin that is an essential oil constituent obtained from natural products such as turpentine or orange peels, and includes a partially hydrogenated terpene phenolic resin obtained by partially hydrogenating the copolymer and a fully hydrogenated terpene phenolic resin obtained by fully hydrogenating the copolymer.

Here, the fully hydrogenated terpene phenolic resin refers to a terpene resin (tackifier resin) obtained by substantially fully hydrogenating a terpene phenolic resin. The partially hydrogenated terpene phenolic resin refers to a terpene resin (tackifier resin) obtained by partially hydrogenating a terpene phenolic resin. The terpene phenolic resin has a terpene-derived double bond and a phenol-derived aromatic ring double bond. Accordingly, the fully hydrogenated terpene phenolic resin means a tackifier resin in which both the terpene site and phenol site are fully or mostly hydrogenated. The partially hydrogenated terpene phenolic resin means a terpene phenolic resin in which the hydrogenation of these sites is not fully but partially performed. Any hydrogenation method and any reaction type may be employed.

Examples of the commercial products of the terpene phenolic resin include YS POLYSTER NH (fully hydrogenated terpene phenolic resin) available from Yasuhara Chemical Co., Ltd.

The UV-curable adhesive composition may contain a defoamer. Non-limiting examples of the defoamer include silicone defoamers, acrylic polymer defoamers, vinyl ether polymer defoamers, and olefin polymer defoamers.

The UV-curable adhesive composition may further contain a known additive such as a viscosity modifier, a silane coupling agent, a sensitizer, a heat-curing agent, a curing retardant, an antioxidant, a storage stabilizer, a dispersant, or a filler, as long as the purposes of the present invention are not impaired. To prevent a reduction in UV reactivity of the UV-curable adhesive composition, the UV-curable adhesive composition preferably contains substantially no organic solvent. Specifically, the amount of the organic solvent is preferably 1.5% by weight or less relative to 100% by weight of the UV-curable adhesive composition.

In the present invention, a cured product is obtained by applying the UV-curable adhesive composition to a substrate at a thickness of 150 μm and irradiating the composition with UV light having a wavelength of 315 nm to 480 nm at an irradiance of 90 mW/cm² and a dose of 1,350 mJ/cm² in an atmospheric environment, and the cured product has a reaction percentage of 80% or higher on both a surface (front surface) facing the atmosphere and a surface (back surface) facing the substrate. At this time, the composition may be irradiated with multiple wavelengths within the wavelength range from 315 nm to 480 nm, as long as the total irradiance is 90 mW/cm² and the dose is 1,350 mJ/cm². The substrate is preferably a PET film having a release-treated surface. Under the conditions above, the UV-curable adhesive composition is applied to the substrate and then irradiated with UV light in the presence of oxygen, with the upper surface of the applied composition not covered with a separator. Therefore, the reaction percentage on the surface (front surface) facing the atmosphere (hereinafter also referred to as “front surface reaction percentage”) reflects the UV reactivity in the presence of oxygen. In contrast, since the coating film has a thickness of 150 μm, the reaction percentage on the surface (back surface) facing the substrate (hereinafter also referred to as “back surface reaction percentage”) reflects the UV reactivity in the absence of oxygen. The reaction percentage of 80% or higher on both the surface (front surface) facing the atmosphere and the surface (back surface) facing the substrate indicates sufficiently high UV reactivity in the presence of oxygen, and thus allows the composition to be used in the method in which the adhesive composition is printed in a desired shape before being bonded to an adherend.

The front surface reaction percentage can be determined by optically analyzing a monomer-derived structure or a polymer-derived structure in the cured product from the atmosphere side (front side). The back surface reaction percentage can be determined by optically analyzing a monomer-derived structure or a polymer-derived structure in the cured product from the substrate side (back side). The optical measurement may be performed by, for example, a method of obtaining an IR spectrum by the attenuated total reflection (ATR) method and determining the vinyl group content of the cured product from the absorbance value at 810 cm⁻¹ in the spectrum.

Specifically, the front surface reaction percentage and the back surface reaction percentage can be measured by the following procedure.

### (Production of Cured Product)

The UV-curable adhesive composition is applied with an applicator to a thickness of 150 μm to a PET sheet having one release-treated surface as the substrate. Subsequently, without sealing the upper surface of the applied composition, the composition is irradiated with UV light with an irradiation energy of 1, 350 mJ/cm² in an atmospheric environment using an UV irradiator set to a UV irradiance of 30 mW/cm² at a wavelength of 365 nm and a UV irradiance of 60 mW/cm² at a wavelength of 405 nm. The UV-curable adhesive composition is thereby cured to provide a cured product.

### (Measurement of Front Surface Reaction Percentage and Back Surface Reaction Percentage)

FIGS. 1 and 2 are views for illustrating a method for calculating the front surface reaction percentage and the back surface reaction percentage. FIG. 1 illustrates a sample preparation method and measurement targets. FIG. 2 illustrates a method for calculating the front surface reaction percentage and the back surface reaction percentage from obtained IR spectra. A sample of the cured product produced as above (cured in an atmospheric environment without sealing the upper surface of the applied composition; see FIG. 1(a)) is defined as a “cured product A”. Another sample is produced by UV light (UV) irradiation in the same manner as for the cured product A, except that a UV-curable adhesive composition 10 is interposed between PET sheets 20 (see FIG. 1(b)). This sample is defined as a “cured product B”.

First, about 0.3 g of the cured product A is placed in an aluminum pan, to which a solvent mixture containing THF, acetone, and ethanol at a THF:acetone:ethanol weight ratio of 8:1:1 is added slowly without splashing the cured product sample, and the sample is left to swell for about two hours. This is followed by drying at 110° C. for 30 minutes, at 170° C. for one hour, and at 190° C. for 30 minutes. After drying, it is confirmed that the mixed solvent has completely evaporated. The aluminum pan after drying and the dried sample are then weighed. The overall reaction percentage is calculated by the following formula.

$$Overall reaction percentage [ \% ] = 100 - ( Total weight of \\ aluminum pan and sample after drying - Weight of aluminum \\ pan before drying ) / ( Total weight of aluminum pan and sample \\ before drying - Weight of aluminum pan before drying ) \times 100$$

Next, the front and back surfaces of the cured product A are subjected to measurement of IR spectra (infrared absorption spectra) as shown in FIG. 2 by the ATR method using a Fourier transform infrared spectrometer, and the absorbance values at 810 cm⁻¹ are obtained. The obtained value of the front surface and the obtained value of the back surface are defined as “Absorbance without PET (front surface)” and “Absorbance without PET (back surface)”, respectively.

Further, the PET sheet is removed from the irradiated surface (front surface) of the cured product B during curing. The surface (front surface) is then subjected to measurement of an IR spectrum as shown in FIG. 2 in the same manner by the ATR method, and the absorbance value at 810 cm⁻¹ is obtained. The obtained value is defined as “Absorbance with PET (front surface)”.

From these values and the overall reaction percentage, the front surface reaction percentage and the back surface reaction percentage are calculated by the following formulas.

$$Front surface reaction percentage [ \% ] = Absorbance without \\ PET ( front surface ) / Absorbance with PET ( front surface ) \\ Back surface reaction percentage [ \% ] = Absorbance without \\ PET ( back surface ) / Absorbance with PET ( front surface )$$

The “Absorbance without PET (front surface)/Absorbance with PET (front surface)” and the “Absorbance without PET (back surface)/Absorbance with PET (front surface)” mean the percentage values of the “Absorbance without PET (front surface)” and the “Absorbance without PET (back surface)”, with the absorbance at 810 cm⁻¹ measured on the uncured UV-curable adhesive composition taken as 0% (minimum) and the “Absorbance with PET (front surface)” as 100% (maximum). For example, the “Absorbance without PET (front surface)/Absorbance with PET (front surface)” means Reaction percentage X in FIG. 2 and is represented by the following formula.

$$Reaction percentage X = B / A \times 100 \\ A = \vert ABS . M - ABS \text{.0} \vert \\ B = \vert ABS . D - ABS \text{.0} \vert$$

To adjust the front surface reaction percentage and back surface reaction percentage of the UV-curable adhesive composition to the range above, the UV reactivity in the presence of oxygen is increased so as to increase the front surface reaction percentage. The front surface reaction percentage may be increased by a method such as: increasing the amount of the nitrogen-containing monomer (A) compounded; increasing the amount of the crosslinking component (C) compounded; using a crosslinking component that in the form of a homopolymer has high gel fraction ((meth)acrylate monomer that in the form of a homopolymer has high gel fraction); using a large amount of the photopolymerization initiator (D); or increasing the amount of the thermoplastic resin (E) (nonreactive component) compounded, for example.

In the present invention, a cured product is obtained by applying the UV-curable adhesive composition to a substrate at a thickness of 150 μm and irradiating the composition with UV light having a wavelength of 315 nm to 480 nm at an irradiance of 90 mW/cm² and a dose of 1, 350 mJ/cm² in an atmospheric environment, and the cured product preferably has a glass transition temperature (Tg) of 20° C. to −30° C. When the glass transition temperature is within the range, the cured product can have excellent adhesion to various substrates. The glass transition temperature is more preferably 1° C. or lower.

The UV-curable adhesive composition may be used for any application, but it is suitable for printing. Applying the composition in a desired pattern by printing on an adherend (substrate) to form a heat-dissipation adhesive layer has the advantage of eliminating the cutting process, as compared with producing an adhesive in a desired shape by cutting an adhesive sheet immediately before bonding. This results in reduced waste production and reduced environmental load. The method for printing is not limited. Examples thereof include screen printing, ink-jet printing, and gravure printing. Preferred among these is screen printing.

The UV-curable adhesive composition may have any viscosity. The UV-curable adhesive composition is preferably a paste having a viscosity at 25° C. of 5 to 500 Pa's as measured using an E-type viscometer. The lower limit of the viscosity is more preferably 10 Pas, and the upper limit thereof is more preferably 100 Pas. The viscosity can be measured using VISCOMETER TV-22 (available from Toki Sangyo Co., Ltd.) as an E-type viscometer with a CP1 cone plate by appropriately selecting a rotation rate of 1 to 100 rpm based on an optimal torque for each viscosity range.

The UV-curable adhesive composition may be prepared by any method. For example, the UV-curable adhesive composition may be prepared by a method of mixing the nitrogen-containing monomer (A), the monofunctional (meth)acrylate monomer (B), the crosslinking component (C), the photopolymerization initiator (D), the thermoplastic resin (E), and optional additives using a mixing device. Examples of the mixing device include a homogenizing disperser, a homogenizer, a universal mixer, a planetary mixer, a kneader, and a triple roll mill.

The present invention also encompasses an adhesive obtained by printing the UV-curable adhesive composition of the present invention and irradiating the UV-curable adhesive composition with UV light. The adhesive of the present invention can be printed in a desired shape by screen printing, for example, and can be used in various applications because of its excellent adhesion to various substrates. The adhesive may be used to bond electronic components inside electronic devices.

The UV-curable adhesive composition forms an adhesive layer when cured by UV irradiation. The UV-curable adhesive composition may be used for a method of forming an adhesive layer on a substrate (separator) to produce an adhesive sheet transferrable onto an adherend, or a method of forming an adhesive layer directly on an adherend. The method of forming an adhesive layer directly on an adherend can minimize the number of times of bonding and also prevent air bubbles at the interface in bonding. The method of forming an adhesive layer on a substrate (separator) has the advantage of having fewer restrictions on application because the adhesive layer is disposed on an adherend by transfer.

In the following, an adhesive sheet containing the UV-curable adhesive composition, a laminate, and a method for producing a laminate are described.

The present invention also encompasses an adhesive sheet including a substrate and an adhesive layer on at least one surface of the substrate, the adhesive layer containing the UV-curable adhesive composition of the present invention.

The substrate is not limited, but it is preferably a resin film. Examples of a material of the resin film include polyester polymers such as polyethylene terephthalate and polyethylene naphthalate, cellulose polymers such as diacetyl cellulose and triacetyl cellulose, acrylic polymers such as polymethyl methacrylate, styrene polymers such as polystyrene and acrylonitrile-styrene copolymers (AS resins), and polycarbonate polymers. Examples of a transparent protective film include polyolefin polymers such as polyethylene, polypropylene, polyolefins having a cyclic or norbornene structure, and ethylene-propylene copolymers, vinyl chloride polymers, amide polymers such as nylons and aromatic polyamides, imide polymers, sulfone polymers, polyether sulfone polymers, polyetheretherketone polymers, polyphenylene sulfide polymers, vinyl alcohol polymers, vinylidene chloride polymers, vinyl butyral polymers, acrylate polymers, polyoxymethylene polymers, epoxy polymers, and mixture of these polymers. The substrate may have any thickness and may have a thickness of about 1 to 500 μm, for example.

The substrate is preferably release-treated so that it can be easily removed after the adhesive layer is bonded to an adherend. For example, the substrate is preferably a release-treated polyethylene terephthalate (PET) sheet.

The adhesive layer can be formed by applying the UV-curable adhesive composition and then irradiating the composition with UV light. The adhesive layer is preferably disposed on part of the substrate by a method such as printing.

The adhesive layer preferably has a thickness of 30 μm or greater, more preferably 50 μm or greater. The adhesive layer having a thickness of 30 μm or greater can have sufficient adhesion. The upper limit of the thickness of the adhesive layer is not limited. The upper limit is preferably 1,000 μm or less, more preferably 500 μm or less for adaptation to reduced thickness of electronic devices.

With the adhesive sheet, a laminate can be produced by bonding one surface (side not contacting the substrate) of the adhesive layer to a first adherend, then removing the substrate, and bonding the other, exposed surface of the adhesive layer to a second adherend. Examples of materials of the first adherend and the second adherend include metals such as stainless steel and aluminum and resins. The present invention also encompasses a laminate including a first adherend and a second adherend bonded to each other with the adhesive layer of the adhesive sheet of the present invention.

The present invention also encompasses a method for producing a laminate, including: applying the UV-curable adhesive composition of the present invention to a first adherend; exposing the UV-curable adhesive composition to light to form an adhesive layer; and bonding a second adherend to the adhesive layer to form a laminate. The UV-curable adhesive composition is preferably applied by ink-jet printing, screen printing, spray coating, spin coating, gravure offset printing, and reverse offset printing. The UV-curable adhesive composition is preferably applied to part of the first adherend.

### Advantageous Effects of Invention

The present invention can provide a UV-curable adhesive composition having excellent printability, excellent UV reactivity in the presence of oxygen, and excellent adhesion to various substrates. The present invention can also provide an adhesive containing the UV-curable adhesive composition.

### BRIEF DESCRIPTION OF DRAWINGS

FIG. 1 is a view illustrating a sample production method and measurement targets to illustrate a method for calculating the front surface reaction percentage and the back surface reaction percentage.

FIG. 2 is a view illustrating a method for calculating the front surface reaction percentage and the back surface reaction percentage from obtained IR spectra.

### DESCRIPTION OF EMBODIMENTS

The present invention is described in more detail below with reference to examples. The present invention is not limited to these examples.

### Examples 1 to 12 and Comparative Examples 1 to 8

Materials were mixed using a planetary stirrer (available from Thinky Corporation, “Thinky Mixer”) in accordance with the formulations shown in Tables 1 and 2 to provide UV-curable adhesive compositions of examples and comparative examples.

The following are the details of the materials expressed in abbreviations in the tables.

NVC: N-vinyl-ε-caprolactam (available from Tokyo Chemical Industry Co., Ltd.)

ACMO: acryloylmorpholine (available from KJ Chemicals Corporation)

DMAA: dimethylacrylamide (available from KJ Chemicals Corporation)

NVA: N-vinylacetamide (available from Showa Denko K.K.)

150D: tetrahydrofurfuryl alcohol acrylic acid multimer ester (available from Osaka Organic Chemical Industry Ltd., “Viscoat #150D”)

IDAA: isodecyl acrylate (available from Osaka Organic Chemical Industry Ltd.)

4HBA: 4-hydroxybutyl acrylate (available from Mitsubishi Chemical Corporation)

CN9004: urethane (bifunctional, available from Sartomer Japan Inc., “CN9004”)

EB3700: bisphenol A epoxy acrylate (bifunctional, available from Daicel-Allnex Ltd., “EBECRYL 3700”) DPHA: dipentaerythritol hexaacrylate (hexafunctional, available from Daicel-Allnex Ltd.)

TPO: Omnirad TPO H (available from IGM Resins B. V)

819: Omnirad 819 (available from IGM Resins B.V)

184: Omnirad 184 (available from IGM Resins B.V)

KS-66: oil compound defoamer containing silicone oil compounded with silica fine powder (available from Shin-Etsu Silicones, “KS-66”)

BYK-052: polymer-type, silicon-free defoamer (available from BYK Japan KK., “BYK-052 N”)

The acrylic polymer used as a thermoplastic resin in the examples and the comparative examples was prepared as follows.

A 2-L separable flask equipped with a thermometer, a stirrer, a nitrogen inlet tube, and a condenser was charged with 100 parts by weight of 2-ethylhexyl acrylate, 3 parts by weight of acrylic acid, 0.1 parts by weight of 2-hydroxyethyl acrylate, and 300 parts by weight of ethyl acetate as a polymerization solvent. Subsequently, nitrogen gas was blown into the reaction vessel for 30 minutes so that the air inside was purged with nitrogen, and the contents of the reaction vessel were heated to 80° C. with stirring. After 30 minutes, 0.5 parts by weight of t-butylperoxy-2-ethylhexanoate (one-hour half life temperature: 92.1° C., ten-hour half-life temperature: 72.1° C.) as a polymerization initiator was diluted with 5 parts by weight of ethyl acetate, and the obtained polymerization initiator solution was dripped into the reaction vessel over six hours. Thereafter, the reaction was further continued at 80° C. for six hours, and then the reaction solution was cooled to provide an acrylic polymer solution.

The obtained solution was diluted with a diluting solvent (solvent mixture of methanol and toluene, with a methanol/toluene weight ratio of 1:2) to provide a solution having a solid content of 20% by weight. Subsequently, this solution was applied to a release-treated PET film to a dried thickness of 100 μm with a coater, and dried at 80° C. for one hour and at 110° C. for one hour, whereby an acrylic polymer was obtained.

### <Evaluation>

The UV-curable adhesive compositions of Examples 1 to 12 and Comparative Examples 1 to 8 and cured products of the compositions were evaluated as follows. Tables 1 and 2 show the results.

The cured products used for evaluation were produced as follows.

### (Production of Cured Product)

The UV-curable adhesive compositions were each applied with an applicator to a thickness of 150 μm to a PET sheet having one release-treated surface (available from Nippa Corporation, “1-E”, thickness 50 μm) as a substrate. Subsequently, without sealing the upper surface of the applied composition, the composition was irradiated with UV light with an irradiation energy of 1, 350 mJ/cm² in an atmospheric environment using a batch-type UV LED curing device (available from Aitec System Co., Ltd., “M UVBA”) set to a UV irradiance of 30 mW/cm² at a wavelength of 365 nm and a UV irradiance of 60 mW/cm² at a wavelength of 405 nm. The UV-curable adhesive composition was thereby cured to provide a cured product.

### (Front Surface Reaction Percentage and Back Surface Reaction Percentage)

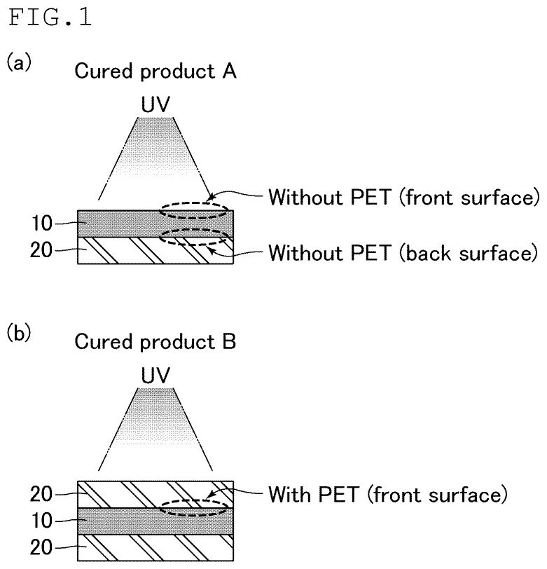

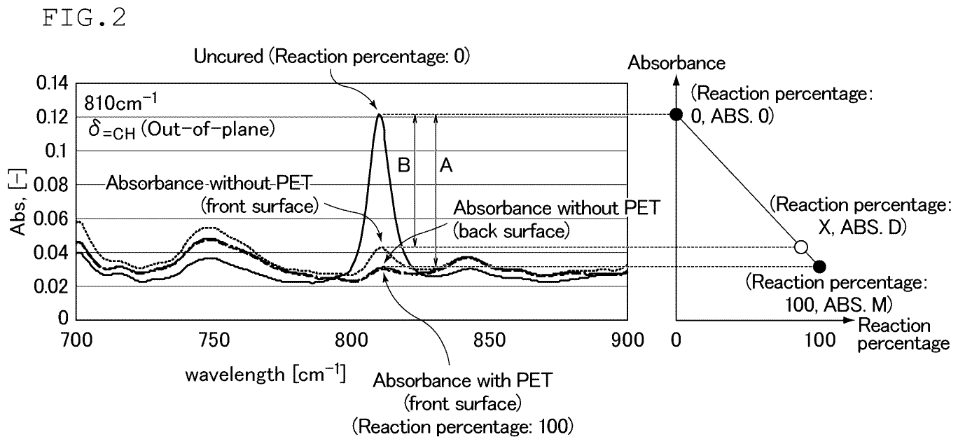

FIGS. 1 and 2 are views for illustrating a method for calculating the front surface reaction percentage and the back surface reaction percentage. FIG. 1 illustrates a sample preparation method and measurement targets. FIG. 2 illustrates a method for calculating the front surface reaction percentage and the back surface reaction percentage from obtained IR spectra. A sample of the cured product produced as above (cured in an atmospheric environment without sealing the upper surface of the applied composition; see FIG. 1(a)) was defined as a “cured product A”. Another sample was produced by UV light (UV) irradiation in the same manner as for the cured product A, except that a UV-curable adhesive composition 10 was interposed between PET sheets 20 (see FIG. 1(b)). This sample was defined as a “cured product B”.

First, about 0.3 g of the cured product A was placed in an aluminum pan, to which a solvent mixture containing THF, acetone, and ethanol at a THF:acetone:ethanol weight ratio of 8:1:1 was added slowly without splashing the cured product sample, and the sample was left to swell for about two hours. This was followed by drying at 110° C. for 30 minutes, at 170° C. for one hour, and at 190° C. for 30 minutes. After drying, it was confirmed that the mixed solvent had completely evaporated. The aluminum pan after drying and the dried sample were then weighed. The overall reaction percentage was calculated by the following formula.

$$Overall reaction percentage [ \% ] = 100 - ( Total weight of \\ aluminum pan and sample after drying - Weight of aluminum \\ pan before drying ) / ( Total weight of aluminum pan and sample \\ before drying - Weight of aluminum pan before drying ) \times 100$$

Next, the front and back surfaces of the cured product A were subjected to measurement of IR spectra (infrared absorption spectra) as shown in FIG. 2 by the ATR method using a Fourier transform infrared spectrometer (Nicolet iS5 FT-IR), and the absorbance values at 810 cm⁻¹ were obtained. The obtained value of the front surface and the obtained value of the back surface were defined as “Absorbance without PET (front surface)” and “Absorbance without PET (back surface)”, respectively.

Further, the PET sheet was removed from the irradiated surface (front surface) of the cured product B during curing. The surface (front surface) was then subjected to measurement of an IR spectrum as shown in FIG. 2 in the same manner by the ATR method, and the absorbance value at 810 cm⁻¹ was obtained. The obtained value was defined as “Absorbance with PET (front surface)”.

From these values, the front surface reaction percentage and the back surface reaction percentage were calculated by the following formulas.

$$Front surface reaction percentage [ \% ] = Absorbance without \\ PET ( front surface ) / Absorbance with PET ( front surface ) \\ Back surface reaction percentage [ \% ] = Absorbance wihtout \\ PET ( back surface ) / Absorbance with PET ( front surface )$$

The “Absorbance without PET (front surface)/Absorbance with PET (front surface)” and the “Absorbance without PET (back surface)/Absorbance with PET (front surface)” mean the percentage values of the “Absorbance without PET (front surface)” and the “Absorbance without PET (back surface)”, with the absorbance at 810 cm⁻¹ measured on the uncured UV-curable adhesive composition taken as 0% (minimum) and the “Absorbance with PET (front surface)” as 100% (maximum). For example, the “Absorbance without PET (front surface)/Absorbance with PET (front surface)” means Reaction percentage X in FIG. 2 and is represented by the following formula.

$$Reaction percentage X = B / A \times 100 \\ A = \vert ABS . M - ABS \text{.0} \vert \\ B = \vert ABS . D - ABS \text{.0} \vert$$

### (Tg)

The cured products obtained as above were each subjected to measurement using a dynamic viscoelasticity measuring apparatus (available from IT Keisoku Seigyo K. K, “DVA-200”) under the following conditions. The tan δ peak temperature was defined as the Tg.

### [Measurement Conditions]

### Shear Method

Measurement temperature: −100° C. to 200° C.
Temperature increase rate: 3° C./min

### Strain: 0.8%

### Frequency: 1 Hz

### (Screen Printability)

The UV-curable adhesive compositions were each evaluated for screen printability using a screen printer (“SSA-PC560E”, available from SERIA). The UV-curable adhesive compositions were each applied in a hollow square (22-mm sides) pattern with a thickness of 100 μm and a width of 1 mm onto a PET sheet (available from Nippa Corporation “1-E”, thickness 50 μm) using a patterned 70-mesh printing plate. The state of the coating film was observed and evaluated in accordance with the criteria below.

### [Air Bubbles]

o (Good): No air bubble was formed in the coating film.
x (Poor): An air bubble was formed in the coating film.

### [Film Thickness]

o (Good): The coating film did not protrude from the pattern due to dripping.
x (Poor): The coating film protruded from the pattern.

### (Viscosity)

The viscosity was measured using VISCOMETER TV-22 (available from Toki Sangyo Co., Ltd.) as an E-type viscometer with a CP1 cone plate at a rotation rate of 10 rpm with 0.4 mL of a collected sample. The viscosity was measured at 100 rpm only in Comparative Example 5.

### (Room Temperature Adhesive Force and High Temperature Adhesive Force: Peel Test)

The UV-curable adhesive compositions were each applied to a thickness of 150 μm to the inner treated surface of an easy adhesion polyester film (“COSMOSHINE A4100”, available from Toyobo Co., Ltd.) with an applicator. Subsequently, without sealing the upper surface of the applied composition, the composition was irradiated with UV light with an irradiation energy of 1,350 mJ/cm² in an atmospheric environment using a batch-type UV LED curing device (available from Aitec System Co., Ltd., “M UVBA”) set to a UV irradiance of 30 mW/cm² at a wavelength of 365 nm and a UV irradiance of 60 mW/cm² at a wavelength of 405 nm. The UV-curable adhesive composition was thereby cured to provide a cured product. The surface facing the atmosphere was sealed with a PET sheet having one release-treated surface (available from Nippa Corporation, “1-E”, thickness 50 μm), and the workpiece was cut to prepare five specimens each having a width of 25 mm and a length of 200 mm (surface to be bonded 125 mm). The sealing PET sheet having one release-treated surface was then removed from each specimen. An adherend was bonded to the exposed surface and pressure-bonded by moving a 2-kg roller back and forth once thereon. The pressure-bonded specimen was subjected to 180° peeling at a speed of 300 mm/min using a universal tester (available from A AND D Company, Ltd., “TENSILON RTI-1310”). The room temperature adhesive force was measured using a specimen adjusted to 25° C. The evaluation at high temperature (60° C.) was performed in a chamber using a thermostatic chamber (Mita Sangyo K.K.). The room temperature adhesive force and the high temperature adhesive force were each measured for adherends of four materials, glass, ABS, Cu, and Al, and evaluated in accordance with the criteria below.

### [Room Temperature Adhesive Force]

oo (Excellent): 20 N/inch or greater
o (Good): 10 N/inch or greater and less than 20 N/inch
A (Fair): 5 N/inch or greater and less than 10 N/inch
x (Poor): less than 5 N/inch

### [High Temperature Adhesive Force]

o (Good): 5 N/inch or greater
x (Poor): less than 5 N/inch

TABLE 1

| | | | Example | | | | | | | | | | | |
|---|---|---|---|---|---|---|---|---|---|---|---|---|---|---|
| | | | 1 | 2 | 3 | 4 | 5 | 6 | 7 | 8 | 9 | 10 | 11 | 12 |
| (A) Nitrogen- | Lactam | NVC | 32.8 | 32.8 | — | — | — | 32.8 | 32.8 | 32.8 | 32.8 | 32.8 | 20 | 10 |
| containing | Non-lactam | ACMO | — | — | 32.8 | — | — | — | — | — | — | — | — | — |
| monomer | | DMAA | — | — | — | 32.8 | — | — | — | — | — | — | — | — |
| | | NVA | — | — | — | — | 20 | — | — | — | — | — | — | — |
| (B) Monofunctional | | 150D | 7.6 | 7.6 | 7.6 | 7.6 | 7 | 7.6 | 7.6 | 7.6 | 7.6 | 7.6 | 7 | 17 |
| (meth)acrylate monomer | | IDAA | 50.7 | 50.7 | 50.7 | 50.7 | 70 | 50.7 | 50.7 | 50.7 | 50.7 | 50.7 | 70 | 70 |
| | | 4HBA | 7.6 | 7.6 | 7.6 | 7.6 | 3 | 7.6 | 7.6 | 7.6 | 7.6 | 7.6 | 3 | 3 |
| (C) Crosslinking | Bifunctional urethane | CN9004 | 2 | 2 | 2 | 2 | 5 | — | — | 2 | 2 | 2 | 5 | 5 |
| component | Bifunctional | EB3700 | — | — | — | — | — | 2 | — | — | — | — | — | — |
| | epoxy acrylate | | | | | | | | | | | | | |
| | Hexafunctional acrylate | DPHA | — | — | — | — | — | | 1 | — | — | — | — | — |
| (D) Photopolymerization initiator | | TPO | 0.6 | 0.6 | 0.6 | 0.6 | 0.6 | 0.6 | 0.6 | — | — | 0.5 | 0.5 | 0.5 |
| | | 819 | — | — | — | — | — | — | — | 0.6 | — | 0.5 | 0.5 | 0.5 |
| | | 184 | — | — | — | — | — | — | — | — | 0.6 | 0.5 | 0.5 | 0.5 |
| (E) Thermoplastic resin | | Acrylic | 25 | 25 | 25 | 25 | 25 | 25 | 25 | 25 | 25 | 25 | 25 | 25 |
| having no reactivity | | polymer | | | | | | | | | | | | |
| Defoamer | Silicone | KS-66 | 1.2 | — | 1.2 | 1.2 | 1.2 | 1.2 | 1.2 | 1.2 | 1.2 | 1.2 | 1.2 | 1.2 |
| | Non-silicone | BYK-052 | — | 1.2 | — | — | — | — | — | — | — | — | — | — |
| Reaction percentage (%) | | Front surface | 95.2 | 98.5 | 88.3 | 85.0 | 88.3 | 86.6 | 86.5 | 91.3 | 84.9 | 90.5 | 94.5 | 91.3 |
| | | Back surface | 98.2 | 97.2 | 84.2 | 88.8 | 84.2 | 86.5 | 92.7 | 94.2 | 84.2 | 92.7 | 97.8 | 95.3 |
| Tg (° C.) | | | 0.2 | 0.2 | −10 | −27 | 1 | 0.5 | 0.7 | −2.3 | −7 | 0.2 | −15 | −25 |
| Screen printability | | Air bubbles | ○ | ○ | ○ | ○ | ○ | ○ | ○ | ○ | ○ | ○ | ○ | ○ |
| | | Film thickness | ○ | ○ | ○ | ○ | ○ | ○ | ○ | ○ | ○ | ○ | ○ | ○ |

| Viscosity (Pa · s) | | 12.4 | 12.8 | 10.8 | 5.8 | 3.2 | 15.2 | 12.5 | 12.5 | 12.3 | 12.2 | 11.8 | 10.5 |
|---|---|---|---|---|---|---|---|---|---|---|---|---|---|
| Adhesive force | Glass | ○ | ○ | ○ | ○ | ○ | Δ | Δ | ○ | ○ | ○○ | ○○ | ○○ |
| 25° C. | ABS | ○ | ○ | ○ | ○ | ○ | Δ | Δ | ○ | ○ | ○○ | ○ | ○ |
| | Cu | ○ | ○ | ○ | ○ | ○ | Δ | Δ | ○ | ○ | ○○ | ○○ | ○ |
| | Al | ○ | ○ | ○ | ○ | ○ | Δ | Δ | ○ | ○ | ○○ | ○○ | ○ |
| Adhesive force | Glass | ○ | ○ | ○ | ○ | ○ | ○ | ○ | ○ | ○ | ○ | ○ | ○ |
| 60° C. | ABS | ○ | ○ | ○ | ○ | ○ | ○ | ○ | ○ | ○ | ○ | ○ | ○ |
| | Cu | ○ | ○ | ○ | ○ | ○ | ○ | ○ | ○ | ○ | ○ | ○ | ○ |
| | Al | ○ | ○ | ○ | ○ | ○ | ○ | ○ | ○ | ○ | ○ | ○ | ○ |

| | | | Comparative Example | | | | | | | |
|---|---|---|---|---|---|---|---|---|---|---|
| | | | 1 | 2 | 3 | 4 | 5 | 6 | 7 | 8 |
| (A) Nitrogen- | Lactam | NVC | — | 32.8 | 32.8 | 32.8 | 32.8 | 32.8 | 8 | 2 |
| containing | Non-lactam | ACMO | — | — | — | — | — | — | — | — |
| monomer | | DMAA | — | — | 67.2 | — | — | — | — | — |
| | | NVA | — | — | — | — | — | — | — | — |
| (B) Monofunctional | | 150D | 7.6 | 7.6 | — | 7.6 | 7.6 | 7.6 | 6 | 8 |
| (meth)acrylate monomer | | IDAA | 50.7 | 50.7 | — | 50.7 | 50.7 | 50.7 | 80 | 80 |
| | | 4HBA | 7.6 | 7.6 | 1 | 7.6 | 7.6 | 7.6 | 6 | 8 |
| (C) Crosslinking | Bifunctional urethane | CN9004 | 2 | 2 | 2 | 2 | 2 | — | — | — |
| component | Bifunctional epoxy acrylate | EB3700 | — | — | — | — | — | — | — | — |
| | Hexafunctional acrylate | DPHA | — | — | — | — | — | — | — | — |
| (D) Photopolymerization initiator | | TPO | 0.6 | 0.6 | 0.6 | — | 0.6 | 0.6 | 0.6 | 0.6 |
| | | 819 | — | — | — | — | — | — | — | — |
| | | 184 | — | — | — | — | — | — | — | — |
| (E) Thermoplastic resin | | Acrylic | 25 | 25 | 25 | 25 | | 25 | 25 | 25 |
| having no reactivity | | polymer | | | | | | | | |
| Defoamer | Silicone | KS-66 | 1.2 | — | 1.2 | 1.2 | 1.2 | 1.2 | 1.2 | 1.2 |
| | Non-silicone | BYK-052 | — | — | — | — | — | — | — | — |
| Reaction percentage (%) | | Front surface | 77.3 | 93.4 | 82.7 | 0.4 | 92.2 | 92.8 | 81.5 | 64.2 |
| | | Back surface | 84.5 | 95.2 | 91.5 | 1.0 | 91.5 | 93.3 | 71.2 | 71.1 |
| Tg (° C.) | | | −28 | 0.2 | 57.2 | Not | ○ | −0.8 | 0.2 | −10.5 |
| | | | | | | measurable | | | | |
| Screen printability | | Air bubbles | ○ | x | ○ | ○ | ○ | ○ | ○ | ○ |
| | | Film thickness | ○ | ○ | ○ | ○ | x | ○ | ○ | ○ |

| Viscosity (Pa · s) | | 10.5 | 12.4 | 9.8 | 12.9 | 0.016 | 12.4 | 9.8 | 8.8 |
|---|---|---|---|---|---|---|---|---|---|
| Adhesive force | Glass | ○ | ○ | x | x | ○ | ○ | ○ | x |
| 25° C. | ABS | ○ | ○ | x | x | ○ | ○ | x | x |
| | Cu | ○ | ○ | x | x | ○ | ○ | x | x |
| | Al | ○ | ○ | x | x | ○ | ○ | ○ | x |
| Adhesive force | Glass | x | ○ | x | x | ○ | x | x | x |
| 60° C. | ABS | x | ○ | x | x | ○ | x | x | x |
| | Cu | x | ○ | x | x | ○ | x | x | x |
| | Al | x | ○ | x | x | ○ | x | x | x |

### INDUSTRIAL APPLICABILITY

The present invention can provide a UV-curable adhesive composition having excellent printability, excellent UV reactivity in the presence of oxygen, and excellent adhesion to various substrates. The present invention can also provide an adhesive containing the UV-curable adhesive composition.

### REFERENCE SIGNS LIST

10: UV-curable adhesive composition
20: PET sheet

1. A UV-curable adhesive composition comprising:
(A) a nitrogen-containing monomer;
(B) a monofunctional (meth)acrylate monomer;
(C) a crosslinking component;
(D) a photopolymerization initiator; and
(E) a thermoplastic resin having no reactivity with the nitrogen-containing monomer (A) nor with the monofunctional (meth)acrylate monomer (B),
a cured product being obtained by applying the composition to a substrate at a thickness of 150 μm and irradiating the composition with UV light having a wavelength of 315 nm to 480 nm at an irradiance of 90 mW/cm² and a dose of 1,350 mJ/cm² in an atmospheric environment, the cured product having a reaction percentage of 80% or higher on both a surface facing the atmosphere and a surface facing the substrate.

2. The UV-curable adhesive composition according to claim 1,
wherein the nitrogen-containing monomer (A) is contained in an amount of 10 to 35% by weight.

3. The UV-curable adhesive composition according to claim 1, further comprising a defoamer.

4. The UV-curable adhesive composition according to claim 1,
wherein the cured product has a glass transition temperature of 20° C. to −30° C.

5. The UV-curable adhesive composition according to claim 1, which is used for screen printing.

6. An adhesive obtained by printing the UV-curable adhesive composition according to claim 1 and irradiating the curable adhesive composition with UV light.

7. An adhesive sheet comprising:
a substrate; and
an adhesive layer on at least one surface of the substrate, the adhesive layer containing the UV-curable adhesive composition according to claim 1.

8. The adhesive sheet according to claim 7,
wherein the adhesive layer is disposed on part of the substrate.

9. A laminate comprising a first adherend and a second adherend bonded to each other with the adhesive layer of the adhesive sheet according to claim 7.

10. A method for producing a laminate, comprising:
applying the UV-curable adhesive composition according to claim 1 to a first adherend;
exposing the UV-curable adhesive composition to light to form an adhesive layer; and
bonding a second adherend to the adhesive layer to form a laminate.

11. The method for producing a laminate according to claim 10,
wherein the UV-curable adhesive composition is applied by ink-jet printing, screen printing, spray coating, spin coating, gravure offset printing, or reverse offset printing, and the UV-curable adhesive composition is applied to part of the first adherend.
